(19) United States
(12) Patent Application Publication
(10) Pub. No.: US 2026/0104027 A1
(43) Pub. Date: Apr. 16, 2026

(54) LOAD CONTROL DEVICE, IGNITER, ENGINE IGNITION DEVICE, AND VEHICLE

(71) Applicant: ROHM CO., LTD., Kyoto-shi (JP)

(72) Inventors: Hiroyuki TANIGAWA, Kyoto-shi (JP); Atsushi TAGUCHI, Kyoto-shi (JP)

(21) Appl. No.: 19/421,345

(22) Filed: Dec. 16, 2025

Related U.S. Application Data
(63) Continuation of application No. PCT/JP2024/021235, filed on Jun. 11, 2024.

(30) Foreign Application Priority Data
Jun. 27, 2023 (JP) 2023-104698

(51) Int. Cl. F02P 3/055

(52) U.S. Cl. CPC F02P 3/055

(57) ABSTRACT

A load control device according to an embodiment includes a switching element having a first main terminal connected to a load and having a second main terminal and a control terminal, a shunt resistor electrically connected between the second main terminal and a ground terminal to detect a current flowing through the switching element, a switch control device configured to output a drive signal to the control terminal for driving the switching element, based on a detection signal derived from a detection result of the shunt resistor and on a control signal from an external control device, and a capacitor electrically connected in parallel with the shunt resistor between the second main terminal and the ground terminal.

### CROSS-REFERENCE TO RELATED APPLICATIONS

This application claims the benefit of priority to Japanese Patent Application No. 2023-104698, filed on Jun. 27, 2023. The entire contents of the above-identified application are hereby incorporated by reference.

### TECHNICAL FIELD

The present invention relates to a load control device, an igniter, an engine ignition device, and a vehicle.

### BACKGROUND

Conventionally, an example of a device including a switching element and a switch control circuit is an igniter. In the igniter, the switching element is connected to the primary coil of an ignition coil. The switch control circuit provided in the igniter controls the switching element in response to an ignition signal. By controlling such a switching element, the igniter controls the ignition coil (see International Patent Publication WO 2019/176501).

### BRIEF DESCRIPTION OF THE DRAWINGS

FIG. 1 is a schematic diagram of a vehicle provided with an engine ignition device.

FIG. 2 is a schematic block diagram of an example of a switch control device.

FIG. 3 is a plan view illustrating an example of a layout of the internal configuration of an igniter.

FIG. 4 is a diagram illustrating a positional relationship between a lead frame and a switching element.

FIG. 5 is a schematic diagram illustrating the reason why the switching element malfunctions.

FIG. 6 is a schematic diagram illustrating a relationship between a gate signal, an emitter voltage, and a gate-emitter voltage in the igniter shown in FIG. 1.

FIG. 7 is a diagram illustrating a modification example of the connection configuration of a capacitor provided in the igniter.

FIG. 8 is a plan view illustrating a first layout example of the internal configuration of the igniter according to the modification example shown in FIG. 7.

FIG. 9 is a plan view illustrating a second layout example of the internal configuration of the igniter according to the modification example shown in FIG. 7.

FIG. 10 is a diagram illustrating a positional relationship between the switching element and the capacitor.

FIG. 11 is a diagram illustrating a configuration example of the vehicle.

### DETAILED DESCRIPTION

Embodiments of the present disclosure will be described with reference to the accompanying drawings. In the description of the drawings, the same elements are denoted by the same reference numerals, and thus description thereof will be omitted.

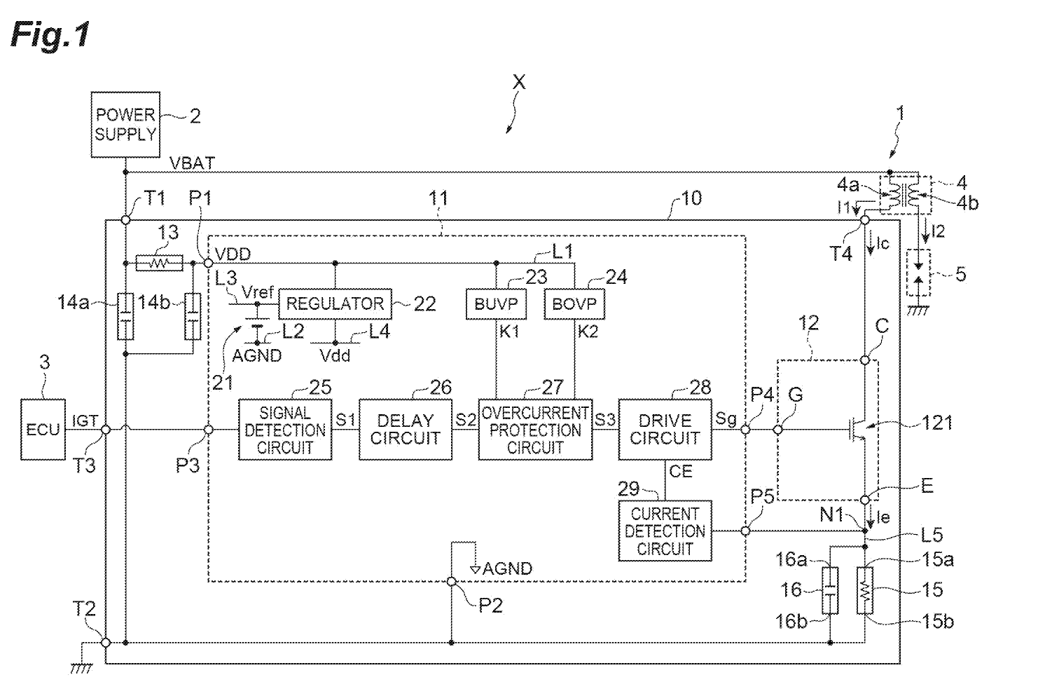

FIG. 1 is a schematic diagram of a vehicle provided with an engine ignition device. Specifically, FIG. 1 is a diagram illustrating the mechanism for driving a gasoline engine in a vehicle X. Although not shown in FIG. 1, the vehicle X also includes components other than those shown in FIG. 1.

As shown in FIG. 1, the vehicle X includes an engine ignition device 1, a power supply 2, and an engine control unit (external control device) 3 as mechanisms for driving a gasoline engine. In the following description, the power supply 2 is a vehicle battery. Hereinafter, the engine control unit 3 is referred to as an engine control unit (ECU) 3.

The engine ignition device 1 operates by receiving a supply of electric power from the power supply 2. The engine ignition device 1 is a device for igniting fuel in a gasoline engine in response to an ignition instruction signal IGT from the ECU 3. The ignition instruction signal IGT is equivalent to the control signal from the ECU 3 which is an external control device. The fuel is a mixture of gasoline and air. The engine ignition device 1 includes an igniter 10, an ignition coil 4, and a spark plug 5.

The ignition coil 4 includes a primary coil 4a and a secondary coil 4b. The first terminals of the primary coil 4a and the secondary coil 4b are electrically connected to the power supply 2. The second terminal of the primary coil 4a is electrically connected to the output terminal T4 of the igniter 10. The second terminal of the secondary coil 4b is electrically connected to the spark plug 5.

The igniter 10 includes a switch control device 11 and a switching element 12. The igniter 10 controls on/off operation of the switching element 12 on the basis of the ignition instruction signal IGT supplied from the ECU 3.

When the switching element 12 is turned on based on the ignition instruction signal IGT, a battery voltage VBAT is applied from the power supply 2 to the primary coil 4a of the ignition coil 4, and a current I1 flowing through the primary coil 4a increases over time. When the switching element 12 is turned off on the basis of the ignition instruction signal IGT, the current I1 of the primary coil 4a is interrupted. In this case, a primary voltage proportional to the time derivative of the current I1 is generated in the primary coil 4a. A secondary voltage obtained by multiplying the primary voltage by a turns ratio is generated in the secondary coil 4b. The secondary voltage thus generated causes the spark plug 5 to generate a spark.

As shown in FIG. 1, the igniter 10 has a high-potential power supply terminal T1 to which a battery voltage VBAT is supplied from the power supply 2 and the output terminal T4 which is electrically connected to the primary coil 4a of the ignition coil 4. The igniter 10 has a signal input terminal T3 which is electrically connected to the ECU 3 and a ground terminal T2 which is connected to the ground. The ignition instruction signal IGT is input to the signal input terminal T3 from the ECU 3.

The igniter 10 includes the switch control device 11, the switching element 12, a resistor 13, a capacitor 14a, a capacitor 14b, a shunt resistor 15, and a capacitor 16. The igniter 10 is modularized and housed in a single package. The switching element 12 is configured as a single semiconductor chip including a transistor 121. In this example, the transistor 121 is an insulated gate bipolar transistor (IGBT). Each of the terminals (C, G, E) of the transistor 121 is sometimes described as a terminal of a semiconductor chip, that is, the switching element 12.

The first terminal of the resistor 13 is electrically connected to the high-potential power supply terminal T1. The second terminal of the resistor 13 is electrically connected to a high-potential power supply terminal P1 of the switch control device 11. The resistor 13 reduces, for example, a surge voltage which is superimposed on the battery voltage VBAT, and mitigates stress on the switch control device 11. The battery voltage VBAT is supplied to the switch control device 11 through the resistor 13 as a high-potential power supply voltage VDD.

The capacitor 14a is electrically connected between the high-potential power supply terminal T1 and the ground terminal T2. The capacitor 14a reduces, for example, noise (for example, spike noise) which is superimposed on the battery voltage VBAT and stabilizes the high-potential power supply voltage VDD.

The capacitor 14b is electrically connected between the second terminal of the resistor 13 and the ground terminal T2. The capacitor 14b functions as, for example, a bypass capacitor that stabilizes the high-potential power supply voltage VDD.

The switch control device 11 has the high-potential power supply terminal P1 which is electrically connected to the second terminal of the resistor 13 and to which the high-potential power supply voltage VDD is input, and a ground terminal P2 which is electrically connected to the ground terminal T2. In the switch control device 11, a wiring that transmits the high-potential power supply voltage VDD from the high-potential power supply terminal P1 is referred to as a first voltage wiring L1, and a wiring that transmits a ground voltage (low-potential voltage) AGND from the ground terminal P2 is referred to as a ground wiring L2.

The switch control device 11 has a signal input terminal P3 which is electrically connected to the signal input terminal T3 and to which the ignition instruction signal IGT is input, an output terminal P4 which is electrically connected to the switching element 12, and an input terminal P5 to which a current flowing from the switching element 12 to the shunt resistor 15 is input.

The switch control device 11 includes a reference voltage source 21, a regulator 22, a low voltage protection circuit (battery under voltage protection (BUVP)) 23, an overvoltage protection circuit (battery over voltage protection (BOVP)) 24, a signal detection circuit 25, a delay circuit 26, an overcurrent protection circuit 27, a drive circuit 28, and a current detection circuit 29.

The reference voltage source 21 generates a reference voltage Vref that serves as a reference for voltage comparison in the switch control device 11. A wiring that transmits the reference voltage Vref generated by the reference voltage source 21 is referred to as a second voltage wiring L3. The reference voltage source 21 is connected between the second voltage wiring L3 and the ground wiring L2. The reference voltage source 21 is, for example, a bandgap reference circuit.

The regulator 22 generates a drive voltage Vdd stabilized at a predetermined level on the basis of the reference voltage Vref and the high-potential power supply voltage VDD. A wiring through which the drive voltage Vdd is transmitted is referred to as a fourth voltage wiring L4.

The low voltage protection circuit 23 compares the high-potential power supply voltage VDD with a predetermined threshold voltage, and outputs a detection signal K1 at a level corresponding to the comparison result. The threshold voltage of the low voltage protection circuit 23 is set, for example, in accordance with the lower limit voltage of a voltage range in which the switch control device 11 can operate.

The overvoltage protection circuit 24 compares the high-potential power supply voltage VDD with a predetermined threshold voltage, and outputs a detection signal K2 at a level corresponding to the comparison result. The threshold voltage of the overvoltage protection circuit 24 is set, for example, in accordance with the upper-limit voltage of a voltage range in which the switch control device 11 can operate.

The signal detection circuit 25 detects the ignition instruction signal IGT from the ECU 3 and outputs a reception signal S1.

The delay circuit 26 imparts a predetermined amount of delay to the reception signal S1. The predetermined amount of delay is set so that the time difference (delay) between the transition of the ignition instruction signal IGT and the discharge of the spark plug 5 is a predetermined value.

The overcurrent protection circuit 27 generates a control signal S3 to be supplied to the drive circuit 28 on the basis of an output S2 from the delay circuit 26, the detection signal K1 of the low voltage protection circuit 23, and the detection signal K2 of the overvoltage protection circuit 24. The overcurrent protection circuit 27 generates the control signal S3 on the basis of the output S2 so that the switching element 12 does not turn on for a predetermined duty protection time.

The drive circuit 28 outputs a gate signal Sg for turning on and off the switching element 12 on the basis of the control signal S3 and a detection signal CE from the current detection circuit 29.

The current detection circuit 29 detects an emitter current Ie flowing from the emitter terminal (second main terminal) E of the switching element 12 to the shunt resistor 15. The emitter current Ie corresponds to a collector current Ic flowing through the switching element 12, and thus the detection result of the emitter current Ie indicates the state of the collector current Ic. The current detection circuit 29 generates the detection signal CE according to the detection result of the emitter current Ie. The detection signal CE is input to the drive circuit 28. The drive circuit 28 lowers the voltage level of the gate signal Sg on the basis of the detection signal CE. For example, the drive circuit 28 lowers the voltage level of the gate signal Sg by adjusting the impedance on the side of the switching element 12 as viewed from the drive circuit 28 in response to the detection signal CE. Thereby, the collector current Ic is limited to or below an upper limit value. Therefore, the current detection circuit 29 also functions as an overcurrent protection circuit.

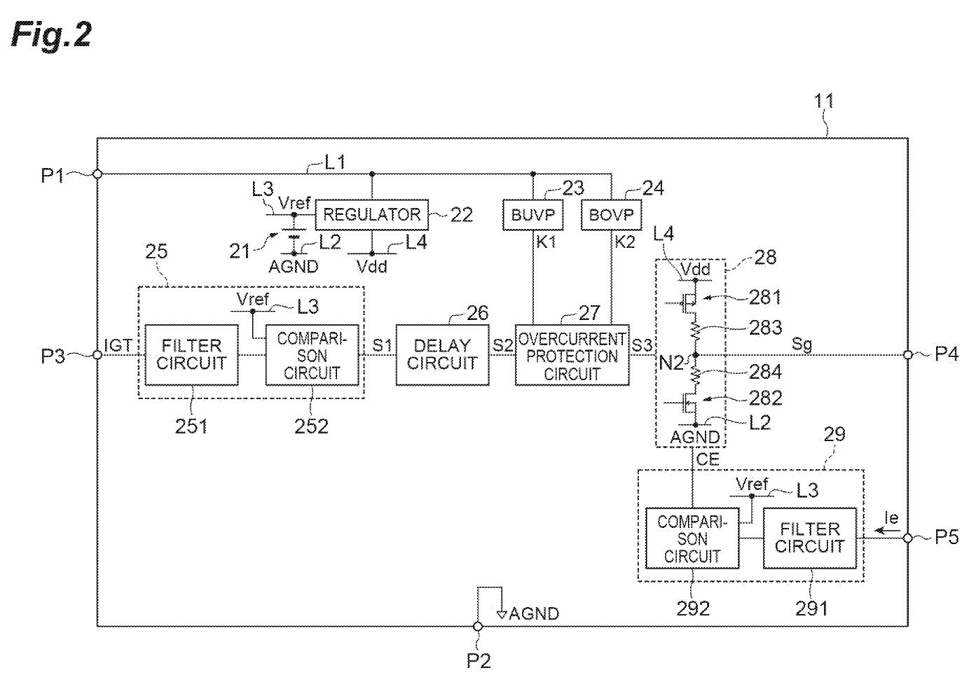

FIG. 2 is a schematic block diagram of an example of the switch control device 11. An example of the signal detection circuit 25, the drive circuit 28, and the current detection circuit 29 will be described with reference to FIG. 2.

An example of the signal detection circuit 25 includes a filter circuit 251 and a comparison circuit 252. The filter circuit 251 receives, as an input, the ignition instruction signal IGT from the signal input terminal P3. The filter circuit 251 is a circuit for removing noise superimposed on the ignition instruction signal IGT. The filter circuit 251 is, for example, an RC filter circuit composed of a resistor and a capacitor. The comparison circuit 252 receives, as inputs, an output from the filter circuit 251 (the ignition instruction signal IGT from which noise has been removed) and the reference voltage Vref. The comparison circuit 252 compares the output from the filter circuit 251 with the reference voltage Vref to generate the reception signal S1.

An example of the drive circuit 28 includes transistors 281 and 282 connected in series between the fourth voltage wiring L4 and the ground wiring L2. The transistor 281 is, for example, a P-channel metal oxide semiconductor field effect transistor (PMOSFET), and the transistor 282 is, for example, an N-channel MOSFET (NMOSFET). A resistor 283 is disposed between the transistor 281 and node N2, which is located between the transistor 281 and the transistor 282. A resistor 284 is disposed between the transistor 282 and the node N2. The node N2 is electrically connected to the output terminal P4. The drive circuit 28 generates the gate signal Sg by adjusting the voltage level of a signal obtained by turning on and off the transistor 281 and the transistor 282 in response to the control signal S3 from the overcurrent protection circuit 27, as necessary, on the basis of the detection signal CE described above.

As described above, in a case where the drive circuit 28 has the transistors 281 and 282 and the resistors 283 and 284 which are connected in series, the influence of noise coming in from the output terminal P4 can be reduced by lowering the on-resistance of the transistors 281 and 282 and the resistance values of the resistors 283 and 284.

An example of the current detection circuit 29 includes a filter circuit 291 and a comparison circuit 292. The filter circuit 291 receives, as an input, the emitter current Ie from the input terminal P5. The filter circuit 291 is a circuit for removing noise superimposed on the emitter current Ie. The filter circuit 291 is an RC filter circuit composed of, for example, a resistor and a capacitor. The comparison circuit 292 receives, as inputs, an output from the filter circuit 291 (a voltage corresponding to the emitter current Ie from which noise has been removed) and the reference voltage Vref. The comparison circuit 292 compares the output from the filter circuit 291 with the reference voltage Vref to generate the detection signal CE.

Referring back to FIG. 1, the igniter 10 will be further described. The switching element 12 includes the transistor 121. A collector terminal C of the switching element 12 is electrically connected to the output terminal T4. Thereby, the collector terminal (first main terminal) C is electrically connected to the primary coil 4a of the ignition coil 4. An emitter terminal (second main terminal) E of the switching element 12 is electrically connected to the ground terminal T2 through the shunt resistor 15. A gate terminal G of the switching element 12 is electrically connected to the output terminal P4. The gate signal Sg is input to the gate terminal G.

The switching element 12 may include a first protection element provided between the gate and collector of the transistor 121 for the purpose of overvoltage protection. The first protection element includes, for example, a diode that is anti-series-connected between the gate and collector of the transistor 121. The diode is, for example, a Zener diode. The first protection element clamps an overvoltage (such as, for example, surge noise) between the gate and collector to a predetermined voltage.

The switching element 12 may include a second protection element provided between the gate and emitter of the transistor 121 for the purpose of overvoltage protection. The second protection element includes, for example, a diode that is anti-series-connected between the gate and emitter of the transistor 121. The diode is, for example, a Zener diode. The second protection element clamps an overvoltage (such as, for example, surge noise) between the gate and emitter to a predetermined voltage.

A first terminal 15a of the shunt resistor 15 is electrically connected to the emitter terminal E, and a second terminal 15b of the shunt resistor 15 is electrically connected to the ground terminal T2. The shunt resistor 15 is a resistor for detecting the state of the emitter current Ie (the collector current Ic of the switching element 12). The resistance value of the shunt resistor 15 is several mΩ to several tens of mΩ, for example, 5 mΩ.

The capacitor 16 is connected in parallel with the shunt resistor 15 between the emitter terminal E and the ground terminal T2. The capacitor 16 is an element for mitigating the influence of noise flowing into the igniter 10 from the output terminal T4. The capacitance of the capacitor 16 need only be a value according to the frequency of noise to be removed.

In a case where a wiring between the first terminal 15a of the shunt resistor 15 and the emitter terminal E is referred to as a wiring L5, a first terminal 16a of the capacitor 16 may be connected closer to the shunt resistor 15 than a node N1 on the wiring L5 or connected to the node N1, or may be connected closer to the emitter terminal E than the node N1.

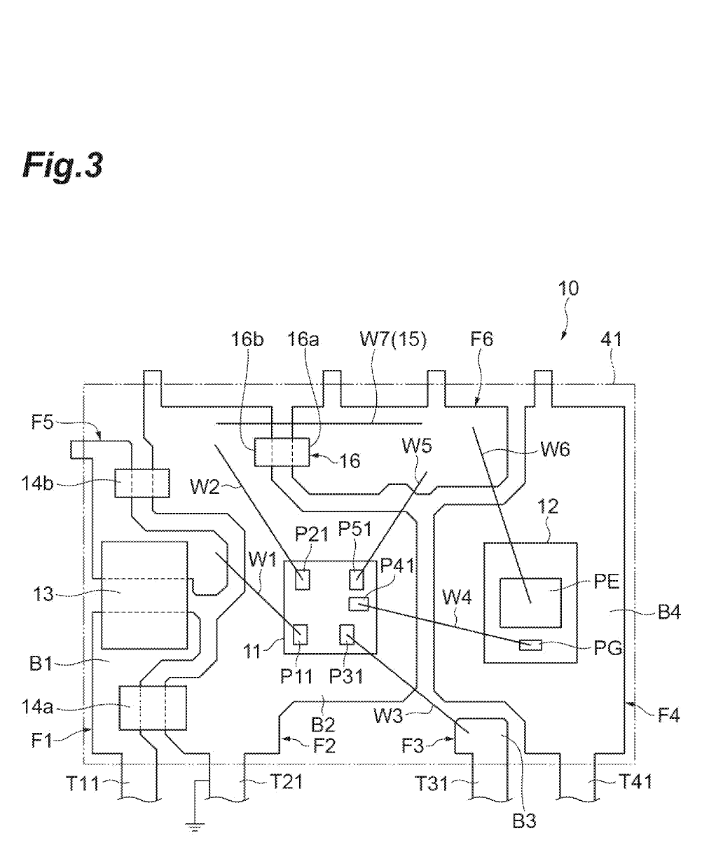

Here, an example of the layout of the internal configuration of the igniter 10 will be described with reference to FIG. 3. FIG. 3 is a diagram corresponding to the configuration in which the first terminal 16a is connected to the node N1 or closer to the shunt resistor 15 than the node N1, as shown in FIG. 1. The configuration in which the first terminal 16a is connected closer to the emitter terminal E than the node N1 on the wiring L5 will be described later as a modification example.

FIG. 3 is a plan view illustrating an example of the layout of the internal configuration of the igniter 10. In FIG. 3, a sealing resin 41 is indicated by a two-dot chain line.

The igniter 10 includes the sealing resin 41 that seals a portion of the lead frame and the constituent components of the igniter 10, and a plurality of lead frame F1, lead frame F2 (first lead frame), lead frame F3, and lead frame (second lead frame) F4 that protrude from the sealing resin 41. The sealing resin 41 is formed in a substantially rectangular parallelepiped shape. Each of the lead frames F1, F2, F3, and F4 protrudes from one lateral side of the sealing resin 41.

The igniter 10 has a lead frame F5 and a lead frame F6 built into the sealing resin 41. Each of the lead frames F1 to F6 can be formed of a conductive metal such as, for example, copper (Cu), a Cu alloy, nickel (Ni), a Ni alloy, or a 42 alloy. The lead frames F1 to F6 may be plated with Pd, Ag, or the like. The sealing resin 41 can be formed of an insulating resin, for example, an epoxy resin.

The lead frames F1, F2, F3, and F4 have mounting portions B1, B2, B3, and B4, and lead portions T11, T21, T31, and T41 extending from the mounting portions B1, B2, B3, and B4. The lead portion T11, the lead portion T21, the lead portion T31, and the lead portion T41 correspond to the high-potential power supply terminal T1, the ground terminal T2, the signal input terminal T3, and the output terminal T4 which are shown in FIG. 1. Since the lead portion T21 corresponds to the ground terminal T2 as described above, the lead frame F2 is connected to ground.

The resistor 13 is connected between the mounting portion B1 of the lead frame F1 and the lead frame F5. The resistor 13 is connected to the mounting portion B1 and the lead frame F5 using Ag paste, solder, or the like.

The capacitor 14a is connected between the mounting portion B1 of the lead frame F1 and the mounting portion B2 of the lead frame F2. The capacitor 14a is connected to the mounting portion B1 and the mounting portion B2 using Ag paste, solder, or the like. The capacitor 14a is mounted closer to the lead portions T11 and T21 than the resistor 13.

The capacitor 14b is connected between the mounting portion B2 of the lead frame F2 and the lead frame F5. The capacitor 14b is connected to the mounting portion B2 and the lead frame F5 using Ag paste, solder, or the like. The capacitor 14b is mounted on the opposite side of the capacitor 14a with the resistor 13 interposed therebetween.

The switch control device 11 is mounted on the mounting portion B2 of the lead frame F2. The switch control device 11 is connected to the mounting portion B2 using Ag paste, solder, or the like. The switch control device 11 is an IC chip. Pads P11, P21, P31, P41, and P51 are exposed on the upper surface of the switch control device 11. The pad P11, the pad P21, the pad P31, the pad P41, and the pad P51 correspond to the high-potential power supply terminal P1, the ground terminal P2, the signal input terminal P3, the output terminal P4, and the input terminal P5 which are shown in FIG. 1.

The switching element 12 is mounted on the mounting portion B4 of the lead frame F4.

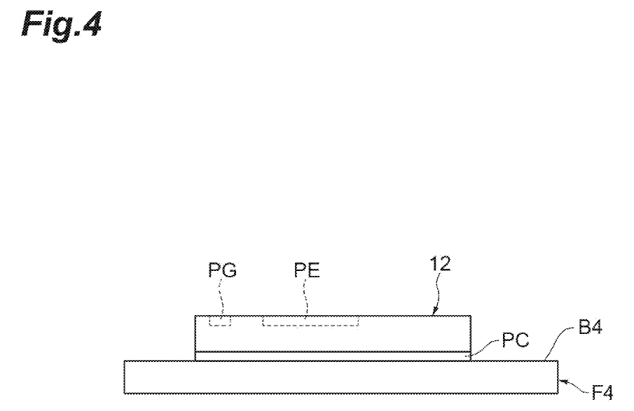

Here, the positional relationship between the switching element 12 and the lead frame F4 will be described with reference to FIG. 4. FIG. 4 is a schematic diagram illustrating the positional relationship between the switching element 12 and the lead frame F4. The switching element 12 has a collector electrode PC on its lower surface, and has a gate pad PG and an emitter pad PE on its upper surface side. The gate pad PG and the emitter pad PE are exposed on the upper surface. The collector electrode PC, the gate pad PG, and the emitter pad PE correspond to the collector terminal C, the gate terminal G, and the emitter terminal E of the switching element 12 shown in FIG. 1.

The collector electrode PC is fixed to the mounting portion B4, and thus the switching element 12 is mounted on the mounting portion B4. In this case, the gate pad PG and the emitter pad PE are located on the side opposite to the lead frame F4 with respect to the switching element 12. The collector electrode PC is fixed to the mounting portion B4 using Ag paste, solder, or the like.

As shown in FIG. 3, the pad P11 is connected to the lead frame F5 by a wire W1.

The pad P21 is connected to the mounting portion B2 of the lead frame F2 by a wire W2.

The pad P31 is connected to the mounting portion B3 of the lead frame F3 by a wire W3.

The pad P41 is connected to the gate pad PG of the switching element 12 by a wire W4.

The pad P51 is connected to the lead frame F6 by a wire W5.

The emitter pad PE of the switching element 12 is connected to the lead frame F6 by a wire W6.

The mounting portion B2 of the lead frame F2 is connected to the lead frame F6 by a wire W7. The wire W7 is disposed opposite to the lead portion T21 with respect to the switch control device 11.

The wires W1, W2, W3, W4, W5, and W6 are, for example, aluminum wires, and have a diameter of, for example, 125 μm. The wire W7 is, for example, an aluminum wire, and has a diameter of, for example, 250 μm. The resistance value of the wire W7 is several mΩ to several tens of mΩ, for example, 5 mΩ. The resistance component of this wire W7 functions as the shunt resistor 15 shown in FIG. 1. Of the wire W7 serving as the shunt resistor 15, the connection end to the lead frame F6 corresponds to the first terminal 15a of the shunt resistor 15, and the connection end to the lead frame F2 corresponds to the second terminal 15b of the shunt resistor 15.

The capacitor 16 is further connected between the mounting portion B2 of the lead frame F2 and the lead frame F6. Thus, the capacitor 16 is connected in parallel with the wire W7 that functions as the shunt resistor 15. In the capacitor 16, the connection portion to the lead frame F6 is a first terminal 16a, and the connection portion to the lead frame F2 is a second terminal 16b. The capacitor 16 is connected to the mounting portion B2 and the lead frame F6 using Ag paste, solder, or the like. The capacitor 16 is disposed closer to the wire W7 than the switch control device 11. The capacitor 16 is disposed parallel to the wire W7.

In the above configuration, the emitter pad PE is connected to the lead frame F2 through the wire W6, the lead frame F6, and the wire W7. The lead portion T21 of the lead frame F2 corresponds to the ground terminal T2. Thus, the emitter pad PE is electrically connected to the lead portion T21 (the ground terminal T2) through the wire W6, the lead frame F6, and the wire W7 (the shunt resistor 15). The pad P51 is connected to the lead frame F6 by the wire W5, and thus the lead frame F6 corresponds to the node N1 shown in FIG. 1. The capacitor 16 and the wire W7 connect the lead frames F2 and F6. Thus, in a case where the lead frame F6 is regarded as the node N1, in the configuration shown in FIG. 3, the first terminal 16a of the capacitor 16 is connected to the node N1.

As shown in FIG. 3, in a case where the connection ends of the wires W5 and W6 to the lead frame F6 are close to each other and far from the capacitor 16, a region where the connection ends of the wires W5 and W6 to the lead frame F6 are gathered can also be regarded as the node N1. In this case, since the capacitor 16 is connected closer to the wire W7 than the wires W5 and W6, it can be said that the first terminal 16a of the capacitor 16 is connected closer to the wire W7 than the node N1.

In the engine ignition device 1 shown in FIG. 1, as described above, when the switching element 12 is turned on based on the ignition instruction signal IGT input from the ECU 3, the battery voltage VBAT is applied from the power supply 2 to the primary coil 4a of the ignition coil 4, and the current I1 flowing through the primary coil 4a increases over time. When the switching element 12 is turned off on the basis of the ignition instruction signal IGT, the current I1 of the primary coil 4a is interrupted. In this case, a primary voltage proportional to the time derivative of the current I1 is generated in the primary coil 4a. A secondary voltage obtained by multiplying the primary voltage by a turns ratio is generated in the secondary coil 4b. The secondary voltage thus generated causes the spark plug 5 to generate a spark.

In a case where the engine ignition device 1 operates as described above, high-frequency noise may be superimposed on the current I1 flowing through the primary coil 4a due to the influence of parasitic capacitance contained in the ignition coil 4. In this case, the high-frequency noise is injected into the igniter 10 from the output terminal T4. In the igniter 10 shown in FIG. 1, the capacitor 16 is connected in parallel with the shunt resistor 15 between the emitter terminal E and the ground terminal T2, and thus the influence of the noise can be reduced. This point will be described specifically.

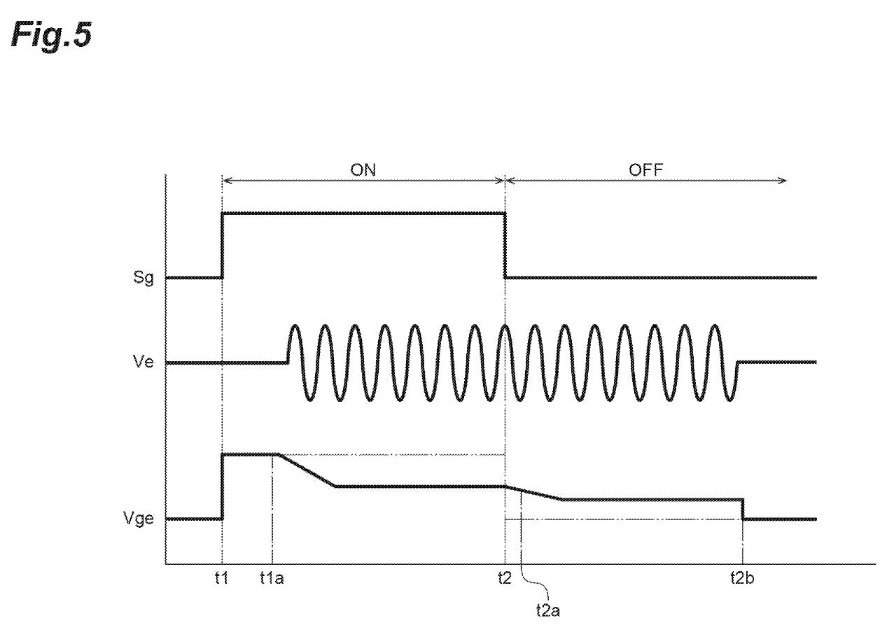

First, a reason why the switching element 12 malfunctions due to noise being superimposed on the current I1 (the collector current Ic) will be described with reference to FIG. 5. FIG. 5 is a schematic diagram illustrating the reason why the switching element 12 malfunctions.

Here, it is assumed that the gate signal Sg input to the gate terminal G of the switching element 12 realizes a desired logic level. In FIG. 5, the logic level of the gate signal Sg is at a high level between time t1 and time t2, and at time t2, the logic level transitions to a low level. In a case where the gate signal Sg is at a high level, the switching element 12 corresponds to the ON state, and in a case where the gate signal Sg is at a low level, the switching element 12 corresponds to the OFF state.

A parasitic capacitance exists between the gate and emitter of the switching element 12 (specifically, the transistor 121). Therefore, in a case where noise is superimposed on the collector current Ic, the level of an emitter voltage Ve is modulated by the parasitic capacitance between the gate and emitter as shown in FIG. 5. In FIG. 5, the wavy line indicates modulation caused by noise.

When the emitter voltage Ve is modulated due to the influence of noise in this way, the gate-emitter voltage Vge varies from a desired level. In FIG. 5, the desired level is indicated by a two-dot chain line.

For example, as shown in FIG. 5, even when the gate signal Sg is at a high level, there are cases where the voltage level of the gate-emitter voltage Vge drops from the desired level as in the voltage level between time t1a and time t2 shown in FIG. 5, and even when the gate signal Sg is at a low level, there are cases where the voltage level of the gate-emitter voltage Vge rises from the desired level as in the voltage level between time t2a and time t2b shown in FIG. 5.

In a case where the voltage level of the gate-emitter voltage Vge decreases from the desired level as in the voltage level between time t1a and time t2, the gate voltage Vg decreases due to the influence of the emitter voltage Ve. As a result, the desired characteristics of the switching element 12 are not satisfied, and the switching element 12 may malfunction. In a case where the voltage level of the gate-emitter voltage Vge is increased from the desired level as in the voltage level between time t2a and time t2b, the gate voltage Vg is increased due to the influence of the emitter voltage Ve. As a result, the switching element 12 may malfunction and turn ON during the period in which it should be in the OFF state.

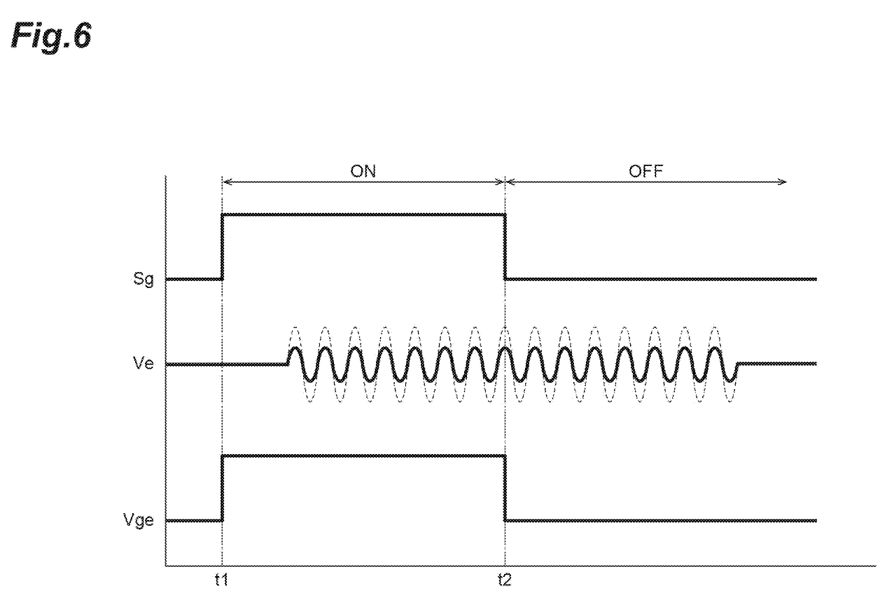

In contrast, in the igniter 10 shown in FIG. 1, the capacitor 16 is provided in parallel with the shunt resistor 15. This lowers the impedance on the wiring L5 side as viewed from the emitter terminal E, and thus the noise level superimposed on the emitter voltage Ve is mitigated as shown in FIG. 6. FIG. 6 is a schematic diagram illustrating the relationship between the gate signal Sg, the emitter voltage Ve, and the gate-emitter voltage Vge in a case where the igniter 10 including the capacitor 16 is in operation. In FIG. 6, the logic level of the gate signal Sg is also at a high level between time t1 and time t2, and at time t2, the logic level transitions to a low level. In a case where the gate signal Sg is at a high level, the switching element 12 corresponds to the ON state, and in a case where the gate signal Sg is at a low level, the switching element 12 corresponds to the OFF state. The broken line shown in FIG. 6 indicates the noise level in the case of FIG. 5. As described above, the noise level is mitigated, and thus a desired level according to the logic level of the gate signal Sg can be realized as the voltage level of the gate-emitter voltage Vge. As a result, it is possible to prevent the switching element 12 from malfunctioning.

As shown in FIG. 1, in the configuration in which the igniter 10 includes the resistor 13 and the capacitors 14a and 14b, the circuit composed of the resistor 13 and the capacitors 14a and 14b functions as a high-frequency filter. Therefore, the resistor 13 and the capacitors 14a and 14b can mitigate the influence of noise injected from the power supply 2 through the high-potential power supply terminal T1. As a result, it is possible to further prevent the switching element 12 from malfunctioning.

As shown in FIG. 2, in a case where the signal detection circuit 25 includes the filter circuit 251, noise contained in the ignition instruction signal IGT can be reduced. In a case where the igniter 10 includes the delay circuit 26, the influence of the noise contained in the ignition instruction signal IGT can be further reduced. As a result, it is possible to further prevent the switching element 12 from malfunctioning.

As shown in FIG. 2, in a case where the current detection circuit 29 includes the filter circuit 291, it is possible to reduce the influence of noise propagating from the input terminal P5 toward the current detection circuit 29 among the noise injected into the igniter 10 from the output terminal T4 shown in FIG. 1. As a result, it is possible to further prevent the switching element 12 from malfunctioning.

As shown in FIG. 2, in a case where the drive circuit 28 includes the transistors 281 and 282 and the resistors 283 and 284 which are connected in series, the influence of noise coming in from the output terminal P4 among the noise injected into the igniter 10 from the output terminal T4 shown in FIG. 1 can be reduced by lowering the on-resistance of the transistors 281 and 282 and the resistance values of the resistors 283 and 284.

### Modification Example

As described above, the capacitor 16 is connected in parallel with the shunt resistor 15 between the emitter terminal E and the ground terminal T2. In FIG. 1, as an example of the connection configuration for the capacitor 16, a case where the first terminal 16a of the capacitor 16 is connected to the node N1 or connected closer to the shunt resistor 15 than the node N1 has been described.

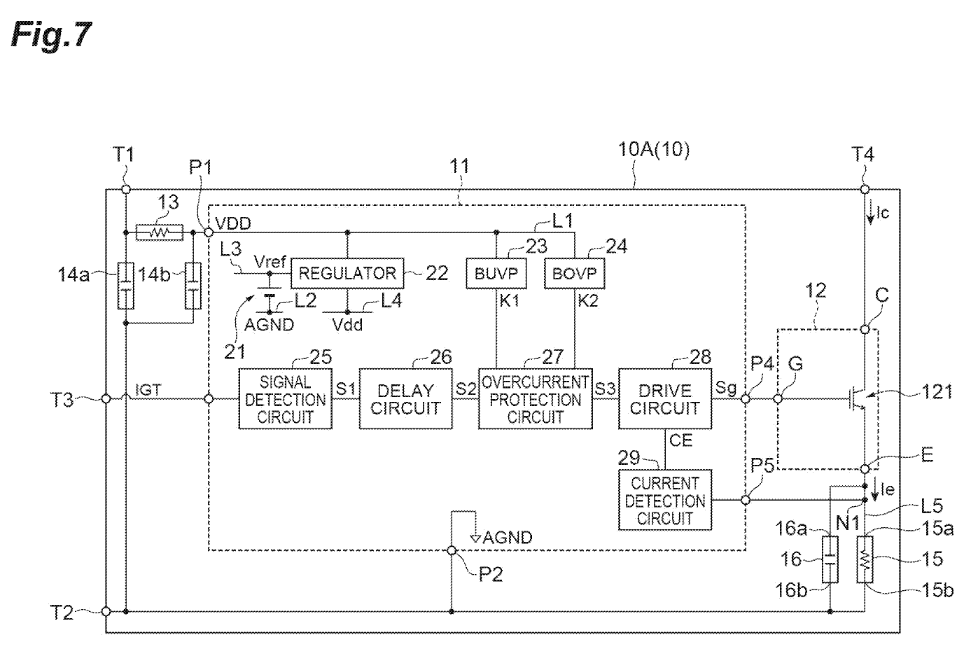

However, as described above, the capacitor 16 may have the first terminal 16a connected closer to the emitter terminal E than the node N1 as shown in FIG. 7. For convenience of description, the igniter 10 shown in FIG. 7 may also be referred to as an igniter 10A.

In the igniter 10A, the first terminal 16a of the capacitor 16 is connected closer to the emitter terminal E than the node N1, so that the electrical length between the emitter terminal E and the first terminal 16a is short. Therefore, the influence of the inductance component contained in the wiring L5 between the emitter terminal E and the shunt resistor 15 can be mitigated. As a result, the influence of noise can be further mitigated. Since the first terminal 16a is connected closer to the emitter terminal E than the node N1, noise superimposed on the emitter current Ie input to the current detection circuit 29 through the input terminal P5 can also be reduced.

### First Layout Example of Internal Configuration of Igniter 10A

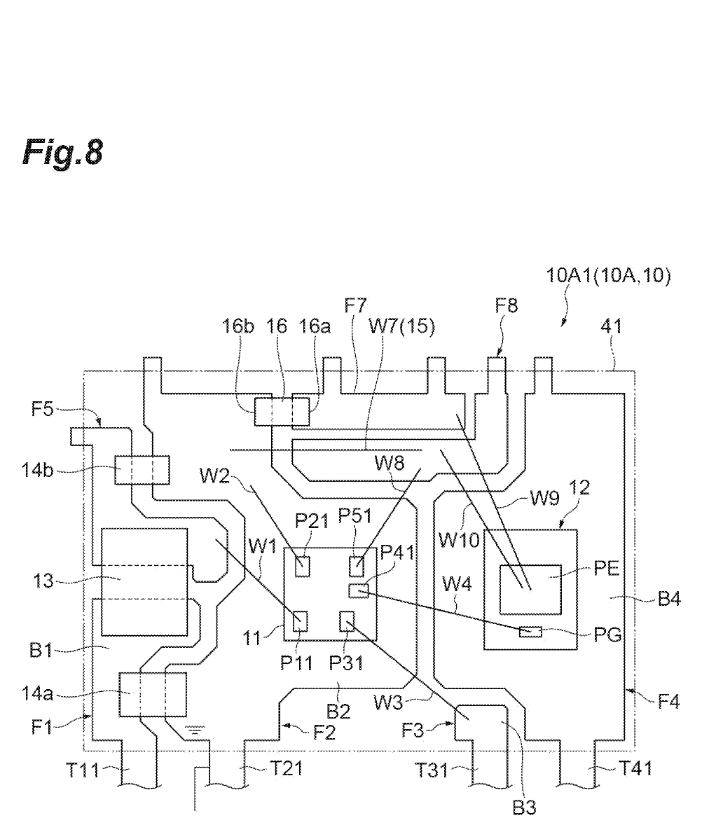

FIG. 8 is a plan view illustrating an example of the layout of the internal configuration of the igniter 10A. In FIG. 8, the sealing resin 41 is indicated by a two-dot chain line. For convenience of description, the igniter 10A (10) shown in FIG. 8 may also be referred to as the igniter 10A1. The same elements as those in the layout example of the igniter 10 shown in FIG. 3 are denoted by the same reference numerals, and thus description thereof will be omitted as appropriate.

The igniter 10A1 includes the sealing resin 41 that seals a portion of the lead frame and the constituent components of the igniter 10A1, and a plurality of lead frame F1, lead frame (first lead frame) F2, lead frame F3, and lead frame (second lead frame) F4 that protrude from the sealing resin 41. The sealing resin 41 is formed in a substantially rectangular parallelepiped shape. Each of the lead frames F1 to F4 protrudes from one lateral side of the sealing resin 41. In FIG. 8, the sealing resin 41 is indicated by a two-dot chain line.

The igniter 10A1 has the lead frame F5, the lead frame F7, and the lead frame F8 built into the sealing resin 41. Each of the lead frames F1 to F5, F7, and F8 can be formed of a conductive metal such as, for example, copper (Cu), a Cu alloy, nickel (Ni), a Ni alloy, or a 42 alloy. The lead frames F1 to F5, F7, and F8 may be plated with Pd, Ag, or the like. The sealing resin 41 can be formed of an insulating resin, for example, an epoxy resin.

The lead frames F1 to F4 have mounting portions B1 to B4 and lead portions T11, T21, T31, and T41 extending from the mounting portions B1 to B4. The lead portions T11, T21, T31, and T41 correspond to each terminal of the igniter 10 shown in FIG. 1. The specific correspondence relation is the same as in the layout example of the igniter 10 shown in FIG. 3.

The resistor 13 is connected between the mounting portion B1 of the lead frame F1 and the lead frame F5. The capacitor 14a is connected between the mounting portion B1 of the lead frame F1 and the mounting portion B2 of the lead frame F2. The capacitor 14b is connected between the mounting portion B2 of the lead frame F2 and the lead frame F5.

The switch control device 11 is mounted on the mounting portion B2 of the lead frame F2. The switching element 12 is mounted on the mounting portion B4 of the lead frame F4.

The gate pad PG and the emitter pad PE are exposed on the upper surface of the switching element 12. The gate pad PG and the emitter pad PE correspond to the gate terminal G and the emitter terminal E shown in FIG. 1. The pads P11, P21, P31, P41, and P51 corresponding to each terminal shown in FIG. 1 are exposed on the upper surface of the switch control device 11. The specific correspondence relation between the pads P11, P21, P31, P41, and P51 and each terminal shown in FIG. 1 is the same as in the layout example of the igniter 10 shown in FIG. 3.

The pad P11 is connected to the lead frame F5 by the wire W1.

The pad P21 is connected to the mounting portion B2 of the lead frame F2 by the wire W2.

The pad P31 is connected to the mounting portion B3 of the lead frame F3 by the wire W3.

The pad P41 is connected to the gate pad PG of the switching element 12 by the wire W4.

The pad P51 is connected to the lead frame F8 by a wire W8.

The emitter pad PE of the switching element 12 is connected to the lead frame F7 by a wire W9. The emitter pad PE is also connected to the lead frame F8 through the wire W10.

The mounting portion B2 of the lead frame F2 is connected to the lead frame F8 through the wire W7. The wire W7 is disposed on the side opposite to the lead portion T21 with respect to the switch control device 11.

The wires W1, W2, W3, W4, W8, W9, and W10 are, for example, aluminum wires, and have a diameter of, for example, 125 μm. The wire W7 is, for example, an aluminum wire, and has a diameter of, for example, 250 μm. The resistance value of the wire W7 is several mΩ to several tens of mΩ, for example, 5 mΩ. The resistance component of the wire W7 functions as the shunt resistor 15 shown in FIG. 1, as in the layout example of the igniter 10 shown in FIG. 3.

The capacitor 16 is connected between the mounting portion B2 of the lead frame F2 and the lead frame F7. The capacitor 16 is connected to the mounting portion B2 and the lead frame F7 using Ag paste, solder, or the like. The capacitor 16 is disposed opposite to the switch control device 11 with respect to the wire W7. The capacitor 16 is disposed parallel to the wire W7.

In the above configuration, the emitter pad PE is connected to the lead frame F2 through the wire W10, the lead frame F8, and the wire W7. The lead frame F2 has the lead portion T21 corresponding to the ground terminal T2, and thus the emitter pad PE is electrically connected to the ground terminal T2 through the wire W7 (the shunt resistor 15). The lead frame F8 is connected to the pad P51 through the wire W8, and thus the lead frame F8 corresponds to the node N1 shown in FIG. 1. The capacitor 16 is connected between the mounting portion B2 of the lead frame F2 and the lead frame F7, and the lead frame F7 is connected to the emitter pad PE through the wire W9. Therefore, in the first layout example of the igniter 10A1 (10A, 10) shown in FIG. 8, the first terminal 16a of the capacitor 16 is electrically connected closer to the emitter pad PE (the emitter terminal E) than the node N1.

### Second Layout Example of Internal Configuration of Igniter 10A

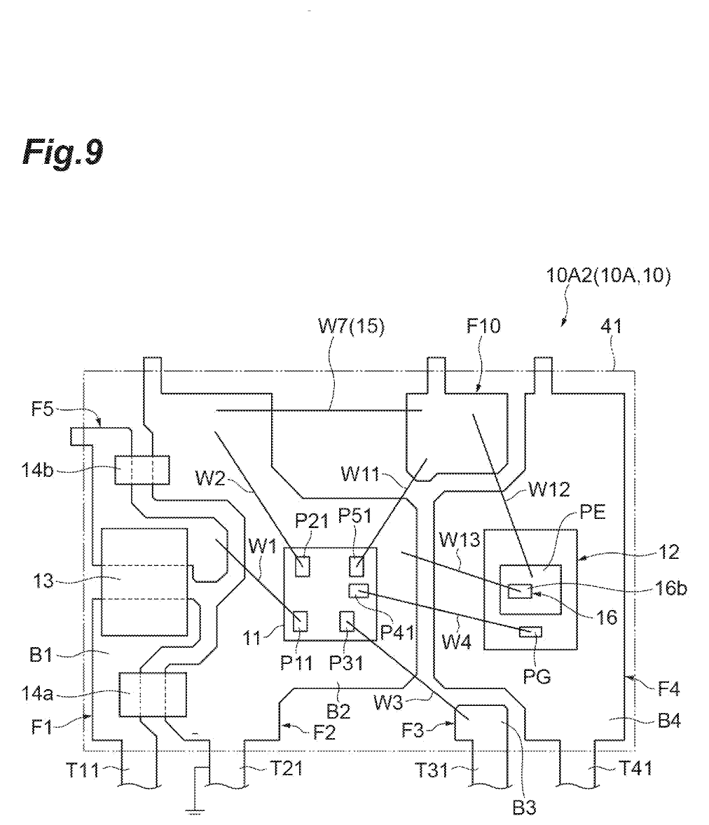

FIG. 9 is a plan view illustrating a second layout example of the internal configuration of the igniter 10A. In FIG. 9, the sealing resin 41 is indicated by a two-dot chain line. For convenience of description, the igniter 10A (10) shown in FIG. 9 may also be referred to as an igniter 10A2. The same elements as those in the layout example shown in FIG. 3 are denoted by the same reference numerals, and thus description thereof will be omitted as appropriate.

The igniter 10A2 includes the sealing resin 41 that seals a portion of the lead frame and the constituent components of the igniter 10A2, and a plurality of lead frame F1, lead frame (first lead frame) F2, lead frame F3, and lead frame (second lead frame) F4 that protrude from the sealing resin 41. The sealing resin 41 is formed in a substantially rectangular parallelepiped shape. Each of the lead frames F1 to F4 protrudes from one side of the sealing resin 41.

The igniter 10A2 has the lead frame F5 and the lead frame (third lead frame) F10 built into the sealing resin 41. Each of the lead frames F1 to F5, F10 can be formed of a conductive metal such as, for example, copper (Cu), a Cu alloy, nickel (Ni), a Ni alloy, or a 42 alloy. The lead frames F1 to F5 and F10 may be plated with Pd, Ag, or the like.

The lead frames F1 to F4 have mounting portions B1 to B4 and lead portions T11, T21, T31, and T41 extending from the mounting portions B1 to B4. The lead portions T11, T21, T31, and T41 correspond to each terminal of the igniter 10 shown in FIG. 1. The specific correspondence relation is the same as that in the layout example shown in FIG. 3.

The resistor 13 is connected between the mounting portion B1 of the lead frame F1 and the lead frame F5. The capacitor 14a is connected between the mounting portion B1 of the lead frame F1 and the mounting portion B2 of the lead frame F2. The capacitor 14b is connected between the mounting portion B2 of the lead frame F2 and the lead frame F5.

The switch control device 11 is mounted on the mounting portion B2 of the lead frame F2. The switching element 12 is mounted on the mounting portion B4 of the lead frame F4.

The gate pad PG and the emitter pad PE are exposed on the upper surface of the switching element 12. The gate pad PG and the emitter pad PE correspond to the gate terminal G and the emitter terminal E shown in FIG. 1. The pads P11, P21, P31, P41, and P51 corresponding to each terminal shown in FIG. 1 are exposed on the upper surface of the switch control device 11. The specific correspondence relation between the pads P11, P21, P31, P41, and P51 and each terminal shown in FIG. 1 is the same as in the layout example shown in FIG. 3.

The pad P11 is connected to the lead frame F5 by the wire W1.

The pad P21 is connected to the mounting portion B2 of the lead frame F2 by the wire W2.

The pad P31 is connected to the mounting portion B3 of the lead frame F3 by the wire W3.

The pad P41 is connected to the gate pad PG of the switching element 12 by the wire W4.

The pad P51 is connected to the lead frame F10 by a wire W11.

The emitter pad PE of the switching element 12 is connected to the lead frame F10 by the wire W12.

The mounting portion B2 of the lead frame F2 is connected to the lead frame F10 through the wire W7. The wire W7 is disposed opposite to the lead portion T21 with respect to the switch control device 11.

The wires W1, W2, W3, W4, W11, and W12 are, for example, aluminum wires, and have a diameter of, for example, 125 μm. The wire W7 is, for example, an aluminum wire, and has a diameter of, for example, 250 μm. The resistance value of the wire W7 is several mΩ to several tens of mΩ, for example, 5 mΩ. The resistance component of the wire W7 functions as the shunt resistor 15 shown in FIG. 1, as in the layout example shown in FIG. 3.

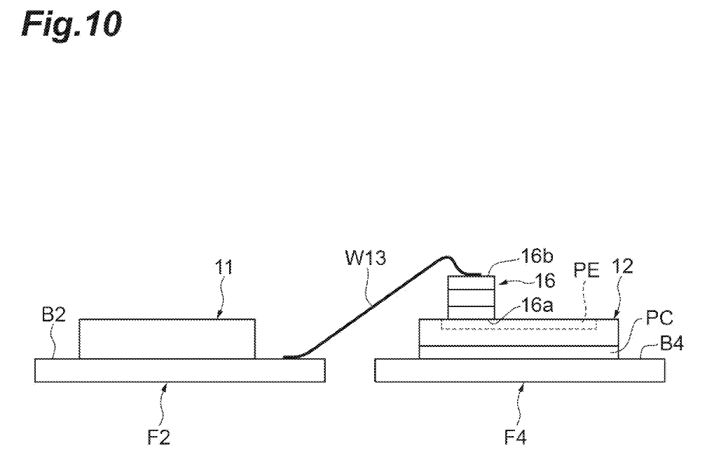

As shown in FIGS. 9 and 10, the capacitor 16 is disposed on the emitter pad PE. FIG. 10 is a schematic diagram illustrating a positional relationship of the capacitor 16 with respect to the switching element 12. FIG. 10 also shows the lead frames F2 and F4 and a wire W13. The capacitor 16 is fixed to the emitter pad PE using Ag paste, solder, or the like. The surface of the capacitor 16 which is fixed to the emitter pad PE corresponds to the first terminal 16a, and the surface opposite to the emitter pad PE corresponds to the second terminal 16b.

The second terminal 16b of the capacitor 16 is connected to the mounting portion B2 of the lead frame F2 by the wire W13. The wire W13 is, for example, an aluminum wire, and has a diameter of, for example, 125 μm.

In the above configuration, the emitter pad PE is connected to the lead frame F2 through the wire W12, the lead frame F10, and the wire W7. The lead frame F2 has the lead portion T21 corresponding to the ground terminal T2, and thus the emitter pad PE is electrically connected to the ground terminal T2 through the wire W7 (the shunt resistor 15). The lead frame F10 is connected to the pad P51 through the wire W11. Thus, the lead frame F10 corresponds to the node N1 shown in FIG. 1. The capacitor 16 is mounted directly on the emitter pad PE. Therefore, the first terminal 16a of the capacitor 16 is connected closer to the emitter pad PE than the node N1.

In a case where the capacitor 16 is mounted on the emitter pad PE as in the second layout example shown in FIG. 9, a wire connecting the first terminal 16a of the capacitor 16 to the emitter pad PE is not required. Therefore, it is possible to mitigate the influence of the inductance component, resistance component, and the like contained in the wire connecting the first terminal 16a of the capacitor 16 to the emitter pad PE.

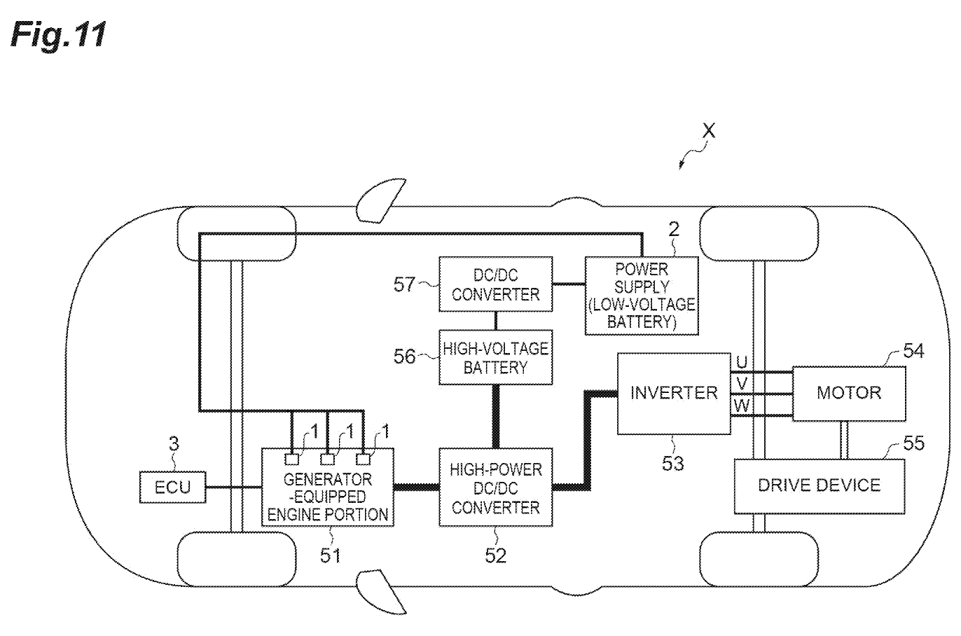

Next, a configuration example of the vehicle X in which the engine ignition device 1 according to the above embodiment is mounted will be described. FIG. 11 is a diagram illustrating a configuration example of a vehicle in which the engine ignition device 1 according to the embodiment is mounted.

The vehicle X includes the power supply 2 and the ECU 3 described above, a generator-equipped engine portion 51, a high-power DC/DC converter 52, an inverter 53, a motor 54, a drive device 55, a high-voltage battery 56, and a DC/DC converter 57. The mounting positions of the components in FIG. 11 are different from the actual positions for the sake of convenience. The vehicle X shown in FIG. 11 is a hybrid vehicle of a so-called series hybrid type.

The generator-equipped engine portion 51 includes a generator, an engine dedicated to generating electricity that rotates the generator, and the engine ignition device 1 according to the various embodiments. Since the energy conversion efficiency of the engine varies greatly depending on the timing of ignition, it is necessary to control the ignition timing by the ECU 3 in consideration of the rotation angle of the crank that converts the reciprocating motion of the piston in the cylinder into rotational motion and the required amount of power generation. Therefore, the engine ignition device 1 according to the embodiment is provided for each cylinder of the engine.

The high-power DC/DC converter 52 converts the DC power generated by the generator of the generator-equipped engine portion 51 into high-voltage DC power. The high-power DC/DC converter 52 supplies the high-voltage DC power to the inverter 53 and the high-voltage battery 56. The high-power DC/DC converter 52 can supply the discharge power which is discharged from the high-voltage battery 56 to the inverter 53. The high-power DC/DC converter 52 can also charge the high-voltage battery 56 with regenerative electric power supplied from the inverter 53 during deceleration of the vehicle X.

The inverter 53 receives DC power from the high-power DC/DC converter 52 and converts the received DC power into three-phase AC power.

The motor 54 is provided with a shaft and rotates the shaft using three-phase AC power supplied from the inverter 53.

The drive device 55 transmits the motive power generated by the rotation of the shaft of the motor 54 to the driving wheels of the vehicle X. In FIG. 11, the rear wheels of the vehicle X are the driving wheels, but the driving wheels are not limited to the rear wheels. That is, the front wheels may be the driving wheels, or both the front wheels and the rear wheels may be the driving wheels.

The DC/DC converter 57 receives DC power from the high-power DC/DC converter 52 and converts the received DC power into low-voltage DC power. The power supply 2 which is a low-voltage battery is charged by low-voltage DC power which is output from the DC/DC converter 57. The discharge power which is discharged from the power supply 2 is supplied to the engine ignition device 1 according to the embodiment, or the like.

The vehicle in which the engine ignition device 1 according to the embodiment is mounted is not limited to a hybrid vehicle such as the vehicle X shown in FIG. 11, and need only be a vehicle provided with an engine.

Although the embodiments and modification examples according to the present disclosure have been described above, the present invention is not limited to the exemplified embodiments. The present invention is defined by the appended claims, and is intended to include all changes and modifications within the meaning and scope equivalent to the claims.

Although an igniter has been described as an example of a load control device, the load control device is not limited to an igniter. Thus, the load to be controlled by the load control device is also not limited to the primary coil included in the ignition coil. The load control device may, for example, control solenoid injection or a load switch.

Although an IGBT is exemplified as a transistor included in the switching element, a metal-oxide-semiconductor field-effect transistor (MOSFET) may be adopted as a transistor.

According to the load control device, the igniter, the engine ignition device, and the vehicle described in the above embodiment and modification examples, it is possible to reduce the influence of noise injected from the load side to be controlled.

The various embodiments and modification examples described above may be combined as appropriate without departing from the spirit of the present invention.

Various embodiments of the present disclosure may be defined as the following supplement notes.

### Supplementary Note 1

### Embodiment, FIG. 1

A load control device (10) comprising:

a switching element (12) having a first main terminal (C) connected to a load (4) and having a second main terminal (E) and a control terminal (G);

a shunt resistor (15) electrically connected between the second main terminal and a ground terminal (T2) to detect a current flowing through the switching element;

a switch control device (11) configured to output a drive signal (Sg) to the control terminal for driving the switching element, based on a detection signal (CE) derived from a detection result of the shunt resistor and on a control signal (IGT) from an external control device (3); and

a capacitor (16) electrically connected in parallel with the shunt resistor between the second main terminal and the ground terminal.

### Supplementary Note 2

### Embodiment, FIGS. 1 and 2

The load control device according to Supplementary Note 1, wherein the switch control device (11) includes

an input terminal (P5) connected to a wiring (L5) connecting the second main terminal and the shunt resistor to receive, as an input, a current flowing from the second main terminal to the shunt resistor,

a current detection circuit (29) configured to detect a current input to the input terminal as a current flowing through the switching element and to output a detection signal, and

a drive circuit (28) configured to generate the drive signal based on a detection signal output from the current detection circuit and on the control signal,

the capacitor has a first terminal (16a) electrically connected to the second main terminal and a second terminal (16b) electrically connected to the ground terminal, and

the first terminal is electrically connected, in the wiring (L5), closer to the shunt resistor than a node (N1) between the wiring and the input terminal, or to the node.

### Supplementary Note 3

### Modification example, FIG. 7

The load control device according to Supplementary Note 1, wherein the switch control device (11) includes

an input terminal (P5) connected to a wiring (L5) connecting the second main terminal and the shunt resistor to receive, as an input, a current flowing from the second main terminal to the shunt resistor,

a current detection circuit (29) configured to detect a current input to the input terminal as a current flowing through the switching element and to output a detection signal, and

a drive circuit (28) configured to generate the drive signal based on a detection signal output from the current detection circuit and on the control signal,

the capacitor (16) has a first terminal (16a) electrically connected to the second main terminal (E) and a second terminal (16b) electrically connected to the ground terminal, and

the first terminal is electrically connected, in the wiring (L5), closer to the second main terminal than a node (N1) between the wiring and the input terminal.

### Supplementary Note 4

### First layout example of constituent components of igniter according to modification example, FIG. 8

The load control device according to Supplementary Notes 1 or 3, further comprising:

a first lead frame (F2) on which the switch control device is mounted and which is electrically connected to ground;

a second lead frame (F4) on which the switching element is mounted;

a third lead frame (F8); and

a fourth lead frame (F7),

wherein the switch control device has an input terminal (equivalent to the pad P51 in FIG. 8) that receives, as an input, a current flowing from the second main terminal to the shunt resistor,

in the switching element, the first main terminal (equivalent to the collector electrode PC shown in FIG. 4) is located opposite to the second main terminal (equivalent to the emitter pad PE in FIG. 8),

the switching element is mounted on the second lead frame by the first main terminal being fixed to the second lead frame,

the first lead frame (F2) and the fourth lead frame (F7) are connected to each other by the capacitor (16),

the first lead frame (F2) and the third lead frame (F8) are connected to each other by the shunt resistor (W7),

the third lead frame (F8) and the second main terminal are connected to each other by a wire (W10),

the fourth lead frame (F7) and the second main terminal are connected to each other by a wire (W9), and

the input terminal (P51) of the switch control device is connected to the third lead frame by a wire (W8).

### Supplementary Note 5

### Second layout example of constituent components of igniter according to modification example, FIGS. 9 and 10

The load control device according to Supplementary Notes 1 or 3, further comprising:

a first lead frame (F2) on which the switch control device (11) is mounted and which is electrically connected to ground;

a second lead frame (F4) on which the switching element (12) is mounted; and

a third lead frame (F10),

wherein the switch control device has an input terminal (equivalent to the pad P51 in FIG. 9) that receives, as an input, a current flowing from the second main terminal to the shunt resistor,

in the switching element, the first main terminal (equivalent to the collector electrode PC shown in FIG. 10) is located opposite to the second main terminal (equivalent to the emitter pad PE in FIGS. 9 and 10),

the switching element (12) is mounted on the second lead frame by the first main terminal being fixed to the second lead frame,

the first lead frame (F2) and the third lead frame (F10) are connected to each other by the shunt resistor (W7),

the capacitor (16) is mounted on the second main terminal by a first terminal (16a) of the capacitor being fixed to the second main terminal (equivalent to the emitter pad PE in FIGS. 9 and 10),

in the capacitor, a second terminal (16b) located opposite to the first terminal (16a) is connected to the first lead frame (F2) by a wire (W13),

the third lead frame (F10) and the second main terminal are connected to each other by a wire (W12), and

the input terminal (equivalent to the pad P51 in FIG. 9) of the switch control device (11) is connected to the third lead frame (F10) by a wire (W11).

### Supplementary Note 6

### Embodiment, FIG. 1

An igniter comprising the load control device (10) according to any one of Supplementary Notes 1 to 5,

wherein the load is an ignition coil (4),

the first main terminal is connected to a primary coil (4a) of the ignition coil, and

the control signal is an ignition instruction signal (IGT).

### Supplementary Note 7

### Embodiment, FIG. 1

An engine ignition device (1) comprising:

an ignition coil (4);

the igniter (10) according to Supplementary Note 6 which is connected to the primary coil (4a) of the ignition coil; and

a spark plug (5) connected to a secondary coil (4b) of the ignition coil.

### Supplementary Note 8

### Vehicle shown in FIG. 11

A vehicle comprising:

the engine ignition device (1) according to Supplementary Note 7;

a power supply (2) configured to supply electric power to the engine ignition device; and

an engine control unit (3) configured to control the engine ignition device.

### Supplementary Note 9

### Embodiment, FIGS. 1 and 2

The load control device according to Supplementary Note 1, wherein the switch control device (11) includes

an input terminal (P5) connected to a wiring (L5) connecting the second main terminal and the shunt resistor to receive, as an input, a current flowing from the second main terminal to the shunt resistor,

a current detection circuit (29) configured to detect a current input to the input terminal as a current flowing through the switching element and to output a detection signal, and

a drive circuit (28) configured to generate the drive signal based on a detection signal output from the current detection circuit and on the control signal.

### Reference Signs List

X Vehicle

1 Engine ignition device

2 Power supply

3 Engine control unit, ECU (external control device)

4 Ignition coil

4a Primary coil

4b Secondary coil

5 Spark plug

10, 10A, 10A1, 10A2 Igniter (load control device)

11 Switch control device

12 Switching element

121 Transistor

C Collector terminal (first main terminal)

E Emitter terminal (second main terminal)

G Gate terminal (control terminal)

13 Resistor

14a Capacitor

14b Capacitor

15 Shunt resistor

15a First terminal

15b Second terminal

16 Capacitor

16a First terminal

16b Second terminal

21 Reference voltage source

22 Regulator

23 Low voltage protection circuit

24 Overvoltage protection circuit

25 Signal detection circuit

251 Filter circuit

252 Comparison circuit

26 Delay circuit

27 Overcurrent protection circuit

28 Drive circuit

281 Transistor

282 Transistor

283 Resistor

284 Resistor

29 Current detection circuit

291 Filter circuit

292 Comparison circuit

41 Sealing resin

52 DC converter

53 Inverter

54 Motor

55 Drive device

56 High-voltage battery

57 DC converter

B1 Mounting portion

B2 Mounting portion

B3 Mounting portion

B4 Mounting portion

P1 High-potential power supply terminal

P2 Ground terminal

L1 First voltage wiring

L2 Ground wiring

P3 Signal input terminal

P4 Output terminal

P5 Input terminal

L3 Second voltage wiring

L4 Fourth voltage wiring

L5 Wiring

N2 Node

N1 Node

F1 Lead frame

F2 Lead frame (first lead frame)

F3 Lead frame

F4 Lead frame (second lead frame)

F5 Lead frame

F6 Lead frame

F7 Lead frame (fourth lead frame)

F8 Lead frame (third lead frame)

F10 Lead frame (third lead frame)

T1 High-potential power supply terminal

T2 Ground terminal

T3 Signal input terminal

T4 Output terminal

T11 Lead portion

T21 Lead portion

T31 Lead portion

T41 Lead portion

P11 Pad

P21 Pad

P31 Pad

P41 Pad

P51 Pad (input terminal)

PC Collector electrode (first main terminal)

PG Gate pad (control terminal)

PE Emitter pad (second main terminal)

W1 Wire

W2 Wire

W3 Wire

W4 Wire

W5 Wire

W6 Wire

W7 Wire

W8 Wire

W9 Wire

W10 Wire

W11 Wire

W12 Wire

W13 Wire

What is claimed is:

1. A load control device comprising:
a switching element having a first main terminal connected to a load and having a second main terminal and a control terminal;
a shunt resistor electrically connected between the second main terminal and a ground terminal to detect a current flowing through the switching element;
a switch control device configured to output a drive signal to the control terminal for driving the switching element, based on a detection signal derived from a detection result of the shunt resistor and on a control signal from an external control device; and
a capacitor electrically connected in parallel with the shunt resistor between the second main terminal and the ground terminal.

2. The load control device according to claim 1, wherein the switch control device includes
an input terminal connected to a wiring connecting the second main terminal and the shunt resistor to receive, as an input, a current flowing from the second main terminal to the shunt resistor,
a current detection circuit configured to detect a current input to the input terminal as a current flowing through the switching element and to output a detection signal, and
a drive circuit configured to generate the drive signal based on a detection signal output from the current detection circuit and on the control signal,
the capacitor has a first terminal electrically connected to the second main terminal and a second terminal electrically connected to the ground terminal, and
the first terminal is electrically connected, in the wiring, closer to the shunt resistor than a node between the wiring and the input terminal, or to the node.

3. The load control device according to claim 1, wherein the switch control device includes
an input terminal connected to a wiring connecting the second main terminal and the shunt resistor to receive, as an input, a current flowing from the second main terminal to the shunt resistor,
a current detection circuit configured to detect a current input to the input terminal as a current flowing through the switching element and to output a detection signal, and
a drive circuit configured to generate the drive signal based on a detection signal output from the current detection circuit and on the control signal,
the capacitor has a first terminal electrically connected to the second main terminal and a second terminal electrically connected to the ground terminal, and
the first terminal is electrically connected, in the wiring, closer to the second main terminal than a node between the wiring and the input terminal.

4. The load control device according to claim 1, further comprising:
a first lead frame on which the switch control device is mounted and which is electrically connected to ground;
a second lead frame on which the switching element is mounted;
a third lead frame; and
a fourth lead frame,
wherein the switch control device has an input terminal that receives, as an input, a current flowing from the second main terminal to the shunt resistor,
in the switching element, the first main terminal is located opposite to the second main terminal,
the switching element is mounted on the second lead frame by the first main terminal being fixed to the second lead frame,
the first lead frame and the fourth lead frame are connected to each other by the capacitor,
the first lead frame and the third lead frame are connected to each other by the shunt resistor,
the third lead frame and the second main terminal are connected to each other by a wire,
the fourth lead frame and the second main terminal are connected to each other by a wire, and
the input terminal of the switch control device is connected to the third lead frame by a wire.

5. The load control device according to claim 1, further comprising:
a first lead frame on which the switch control device is mounted and which is electrically connected to ground;
a second lead frame on which the switching element is mounted; and
a third lead frame,
wherein the switch control device has an input terminal that receives, as an input, a current flowing from the second main terminal to the shunt resistor,
in the switching element, the first main terminal is located opposite to the second main terminal,
the switching element is mounted on the second lead frame by the first main terminal being fixed to the second lead frame,
the first lead frame and the third lead frame are connected to each other by the shunt resistor,
the capacitor is mounted on the second main terminal by a first terminal of the capacitor being fixed to the second main terminal,
in the capacitor, a second terminal located opposite to the first terminal is connected to the first lead frame by a wire, and
the input terminal of the switch control device is connected to the third lead frame by a wire.

6. An igniter comprising the load control device according to claim 1,
wherein the load is an ignition coil,
the first main terminal is connected to a primary coil of the ignition coil, and
the control signal is an ignition instruction signal.

7. An engine ignition device comprising:
an ignition coil;
the igniter according to claim 6 which is connected to the primary coil of the ignition coil; and
a spark plug connected to a secondary coil of the ignition coil.

8. A vehicle comprising:
the engine ignition device according to claim 7;
a power supply configured to supply electric power to the engine ignition device; and
an engine control unit configured to control the engine ignition device.

9. The load control device according to claim 1, wherein the switch control device includes
an input terminal connected to a wiring connecting the second main terminal and the shunt resistor to receive, as an input, a current flowing from the second main terminal to the shunt resistor,
a current detection circuit configured to detect a current input to the input terminal as a current flowing through the switching element and to output a detection signal, and
a drive circuit configured to generate the drive signal based on a detection signal output from the current detection circuit and on the control signal.

10. The load control device according to claim 3, further comprising:
a first lead frame on which the switch control device is mounted and which is electrically connected to ground;
a second lead frame on which the switching element is mounted;
a third lead frame; and
a fourth lead frame,
wherein the switch control device has an input terminal that receives, as an input, a current flowing from the second main terminal to the shunt resistor,
in the switching element, the first main terminal is located opposite to the second main terminal,
the switching element is mounted on the second lead frame by the first main terminal being fixed to the second lead frame,
the first lead frame and the fourth lead frame are connected to each other by the capacitor,
the first lead frame and the third lead frame are connected to each other by the shunt resistor,
the third lead frame and the second main terminal are connected to each other by a wire,
the fourth lead frame and the second main terminal are connected to each other by a wire, and
the input terminal of the switch control device is connected to the third lead frame by a wire.
